(19) United States
(12) Patent Application Publication
(10) Pub. No.: US 2025/0068903 A1
(43) Pub. Date: Feb. 27, 2025

(54) TRAINING AND TUNING OF LARGE LANGUAGE MODELS FOR GENERATING DOMAIN-SPECIFIC PREDICTIONS

(71) Applicant: Optum, Inc., Minnetonka, MN (US)

(72) Inventors: Robert Elliott Tillman, Long Island City, NY (US); Brian Lawrence Hill, Culver City, CA (US); Vijay S. Nori, Roswell, GA (US); Aldo Cordova Palomera, San Diego, CA (US); Eran Halperin, Santa Monica, CA (US); Melikasadat Emami, San Diego, CA (US)

(21) Appl. No.: 18/477,359

(22) Filed: Sep. 28, 2023

Related U.S. Application Data
(60) Provisional application No. 63/578,521, filed on Aug. 24, 2023.

(51) Int. Cl. G06N 3/08; G06N 3/0499

(52) U.S. Cl. CPC G06N 3/08; G06N 3/0499

(57) ABSTRACT

Various embodiments of the present disclosure provide methods, apparatus, systems, computing devices, computing entities, and/or the like for generating a plurality of training embeddings based on a pre-training dataset, wherein the plurality of training embeddings comprises one or more of descriptive embeddings, sequential ordering embeddings, age/time embeddings, locale embeddings, or encounter number embeddings; generating one or more initialized weights associated with respective one or more layers of a machine learning model based on the plurality of training embeddings; generating one or more fine-tuned weights for the machine learning model by updating at least a portion of the one or more initialized weights using a fine-tuning dataset associated with a target classification; and generating, using the machine learning model, one or more prediction scores for one or more prediction encounter data elements associated with the target classification, based on one or more input temporal sequence of encounters data records.

### CROSS REFERENCE TO RELATED APPLICATION

This application claims the priority of U.S. Provisional Application No. 63/578,521, entitled “TRAINING AND TUNING OF LARGE LANGUAGE MODELS FOR GENERATING DOMAIN-SPECIFIC PREDICTIONS,” filed on Aug. 24, 2023, the disclosure of which is hereby incorporated by reference in its entirety.

### BACKGROUND

Traditionally, large language models (LLMs) may be deployed to perform a range of tasks including sentence completion, sentiment analysis, question answering, language translation, and/or the like. However, LLMs are traditionally limited to prediction tasks involving text or language and require large sample sizes to achieve acceptable performance levels. Moreover, machine learning pipelines that leverage LLMs traditionally require significant feature engineering and model tuning, resulting in addition maintenance, development, and processing costs as well as increased processing times.

Various embodiments of the present disclosure make important contributions to traditional LLM techniques by addressing each of these technical challenges.

### BRIEF SUMMARY

In general, various embodiments of the present disclosure provide methods, apparatus, systems, computing devices, computing entities, and/or the like for configuring a machine learning model to generate predictions for encounter data elements. Various embodiments of the present disclosure provide improvements to the modification, pre-training, and fine-tuning of machine learning models, such as LLMs, that expand model prediction capabilities to perform a range of prediction tasks traditionally unachievable using previous techniques. In this manner, some of the embodiments of the present disclosure address technical challenges related to performing predictive data analysis and provide solutions to address the efficiency and reliability shortcomings of existing predictive data analysis solutions.

Various embodiments of the present disclosure make important technical contributions to improving predictive accuracy of a predictive machine learning model comprising a language machine learning model by generating training embeddings associated with data fields of structured data used for pre-training and fine-tuning the language machine learning model. As described herein, a language machine learning model may not be able to encode and/or identify the meaning of content in data fields of structured data. Accordingly, by generating training embeddings for specific types of data, the techniques described herein improve training and provide adaptation of language machine learning models to data, other than text/language, that are not traditionally handled by language machine learning models, such as structured data from databases or electronic record systems comprising codes, descriptions of diagnosis or action, times/dates, or other information.

In some embodiments, a computer-implemented method comprises: generating, by one or more processors, a plurality of training embeddings based on a pre-training dataset, wherein the plurality of training embeddings comprises one or more of descriptive embeddings, sequential ordering embeddings, age/time embeddings, locale embeddings, or encounter number embeddings; generating, by the one or more processors, one or more initialized weights associated with respective one or more layers of a machine learning model based on the plurality of training embeddings; generating, by the one or more processors, one or more fine-tuned weights for the machine learning model by updating at least a portion of the one or more initialized weights using a fine-tuning dataset associated with a target classification; generating, by the one or more processors and using the machine learning model, one or more prediction scores for one or more prediction encounter data elements associated with the target classification, based on one or more input temporal sequence of encounters data records comprising respective one or more input encounter data elements; and initiating, by the one or more processors, the performance of one or more prediction-based actions based on the one or more prediction scores.

In some embodiments, a computing system comprising memory and one or more processors communicatively coupled to the memory, the one or more processors configured to: generate a plurality of training embeddings based on a pre-training dataset, wherein the plurality of training embeddings comprises one or more of descriptive embeddings, sequential ordering embeddings, age/time embeddings, locale embeddings, or encounter number embeddings; generate one or more initialized weights associated with respective one or more layers of a machine learning model based on the plurality of training embeddings; generate one or more fine-tuned weights for the machine learning model by updating at least a portion of the one or more initialized weights using a fine-tuning dataset associated with a target classification; generate, using the machine learning model, one or more prediction scores for one or more prediction encounter data elements associated with the target classification, based on one or more input temporal sequence of encounters data records comprising respective one or more input encounter data elements; and initiate the performance of one or more prediction-based actions based on the one or more prediction scores.

In some embodiments, one or more non-transitory computer-readable storage media including instructions that, when executed by one or more processors, cause the one or more processors to: generate a plurality of training embeddings based on a pre-training dataset, wherein the plurality of training embeddings comprises one or more of descriptive embeddings, sequential ordering embeddings, age/time embeddings, locale embeddings, or encounter number embeddings; generate one or more initialized weights associated with respective one or more layers of a machine learning model based on the plurality of training embeddings; generate one or more fine-tuned weights for the machine learning model by updating at least a portion of the one or more initialized weights using a fine-tuning dataset associated with a target classification; generate, using the machine learning model, one or more prediction scores for one or more prediction encounter data elements associated with the target classification, based on one or more input temporal sequence of encounters data records comprising respective one or more input encounter data elements; and initiate the performance of one or more prediction-based actions based on the one or more prediction scores.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a flowchart diagram of an example process for training a machine learning model in accordance with some embodiments discussed herein.

FIG. 5 is a flowchart diagram of an example process for tokenizing at least a portion of a pre-training dataset in accordance with some embodiments discussed herein.

FIG. 6A provides an operational example of next encounter prediction pre-training in accordance with some embodiments discussed herein.

FIG. 6B provides an operational example of encounter swap prediction pre-training in accordance with some embodiments discussed herein.

FIG. 7 provides an operational example of a machine learning model framework in accordance with some embodiments discussed herein.

FIG. 8 is a flowchart diagram of an example process for performing predictive operations in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

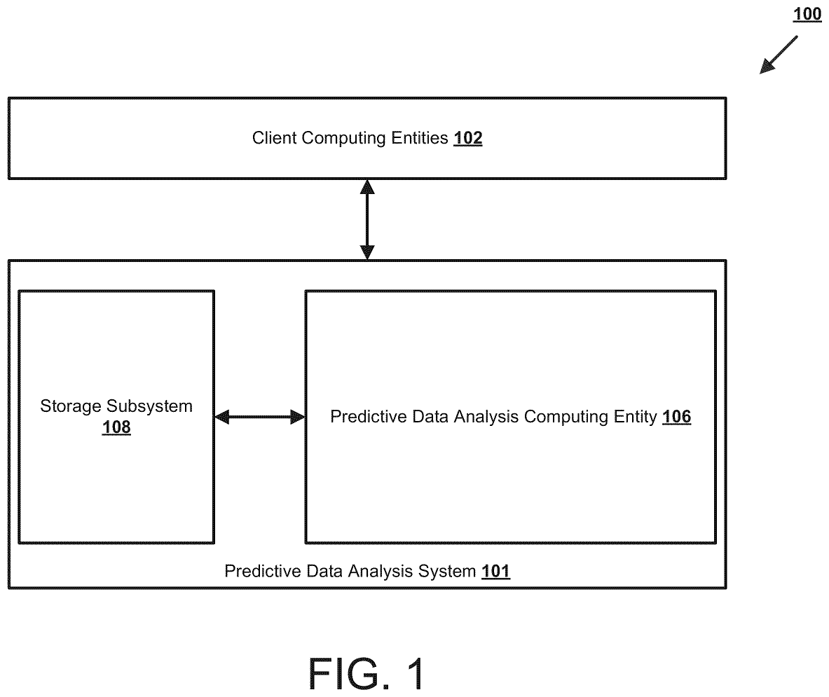

FIG. 1 provides an example overview of an architecture 100 in accordance with some embodiments of the present disclosure. The architecture 100 includes a predictive data analysis system 101 configured to receive predictive data analysis requests from client computing entities 102, process the predictive data analysis requests to generate predictions, provide the generated predictions to the client computing entities 102, and automatically initiate the performance of prediction-based actions based on the generated predictions. The example architecture 100 may be used in a plurality of domains and not limited to any specific application as disclosed herewith. The plurality of domains may include banking, healthcare, industrial, manufacturing, education, retail, to name a few.

An example of a prediction-based action that may be performed using the predictive data analysis system 101 comprises receiving a request for predicting onset of a diagnosis, event, or response to actions/treatments based on an EHR or structured medical claims data (e.g., records from a database) of a patient, generating a prediction, and displaying the prediction on a user interface. Other examples of prediction-based actions comprise generating a diagnostic report, displaying/providing resources, generating, and/or executing action scripts, generating alerts or reminders, or generating one or more electronic communications based on the generated predictions.

In accordance with various embodiments of the present disclosure, a predictive machine learning model may comprise a language machine learning model configured to process structured data via a plurality of training embeddings associated with a plurality of data types. Accordingly, configuring the language machine learning model with the plurality of training embeddings may allow the language machine learning model to handle types of data, other than text/language, that are not traditionally handled by a language machine learning model, such as data in data fields of structured data from databases or electronic record systems comprising codes, descriptions of diagnosis or action, times/dates, or other information. This technique will lead to higher accuracy of performing predictive operations as needed on certain sets of data. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training predictive machine learning models.

In some embodiments, predictive data analysis system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis requests from one or more client computing entities 102, process the predictive data analysis requests to generate predictions corresponding to the predictive data analysis requests, provide the generated predictions to the client computing entities 102, and automatically initiate the performance of prediction-based actions based on the generated predictions.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### A. Example Predictive Data Analysis Computing Entity

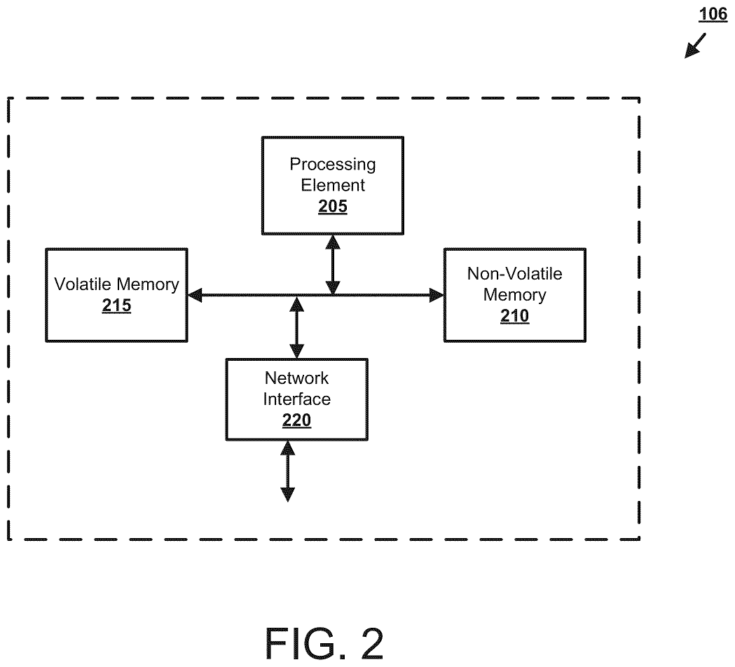

FIG. 2 provides an example predictive data analysis computing entity 106 in accordance with some embodiments of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In some embodiments, these functions, operations, and/or processes may be performed on data, content, information, and/or similar terms used herein interchangeably.

As shown in FIG. 2, in some embodiments, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the predictive data analysis computing entity 106 may further include, or be in communication with, non-volatile media (also referred to as non-volatile storage, memory, memory storage, memory circuitry, and/or similar terms used herein interchangeably). In some embodiments, the non-volatile storage or memory may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In some embodiments, the predictive data analysis computing entity 106 may further include, or be in communication with, volatile media (also referred to as volatile storage, memory, memory storage, memory circuitry, and/or similar terms used herein interchangeably). In some embodiments, the volatile storage or memory may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in some embodiments, the predictive data analysis computing entity 106 may also include one or more network interfaces 220 for communicating with various computing entities, such as by communicating data, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

### B. Example Client Computing Entity

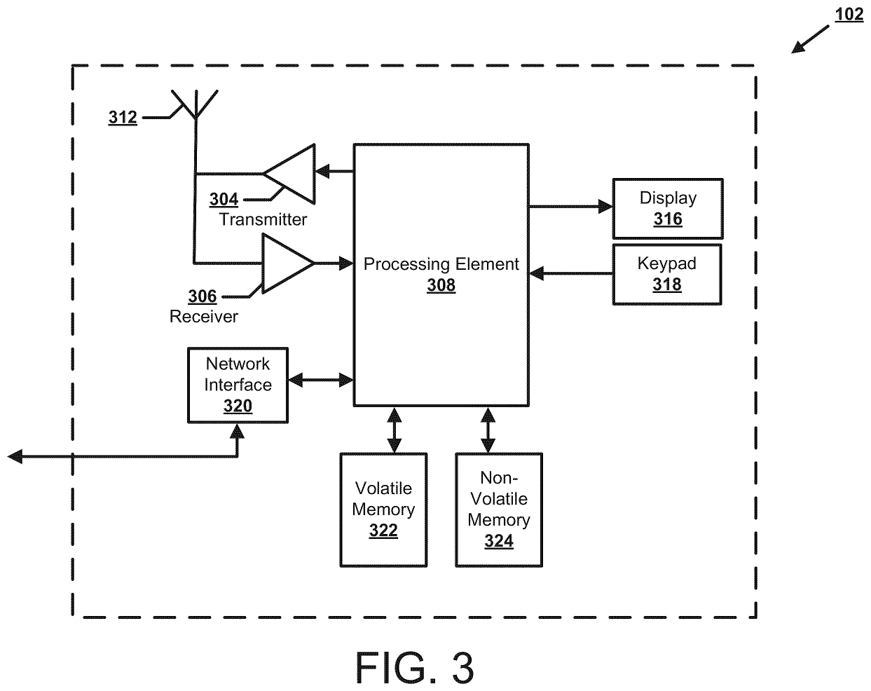

FIG. 3 provides an example client computing entity 102 in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the predictive data analysis computing entity 106. In some embodiments, the client computing entity 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the predictive data analysis computing entity 106 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the predictive data analysis computing entity 106, as described herein. The user input interface may comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the client computing entity 102 or accessible through a browser or other user interface for communicating with the predictive data analysis computing entity 106 and/or various other computing entities.

In another embodiment, the client computing entity 102 may include one or more components or functionalities that are the same or similar to those of the predictive data analysis computing entity 106, as described in greater detail above. As will be recognized, these architectures and descriptions are provided for example purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “embedding” refers to a data construct that describes a latent representation of data comprising one or more features. For example, an embedding of data may be expressed as a vector comprising one or more numbers representative of one or more features associated with content of data. In some embodiments, an embedding may be generated by mapping one or more features to one or more elements in a vector space. According to various embodiments of the present disclosure, the data an embedding represents comprises a feature associated with machine learning model input or training data, such as of a temporal sequence of encounters data record or an input encounter data element of the temporal sequence of encounters data record. One or more embeddings may be generated for machine learning model input or training data such that the machine learning model input or training data may be provided in a format suitable for analysis or processing by a machine learning model, such as a language machine learning model. In some embodiments, a variety of embeddings are generated based on respective one or more types of information represented. As such, generated embeddings may comprise one or more of descriptive embeddings, sequential ordering embeddings, age/time embeddings, locale embeddings, or encounter number embeddings based on the type of feature associated with, for example, encounter data elements of a temporal sequence of encounters data record. Descriptive embeddings may be associated with descriptive features associated with encounter data elements of temporal sequence of encounters data records. For example, descriptive embeddings may be generated from data comprising diagnosis codes (e.g., International Classification of Diseases (ICD) codes), procedure codes (e.g., Current Procedural Terminology (CPT) codes), medications (e.g., generic names), lab results (e.g., Logical Observation Identifiers, Names and Codes (LOINC) codes), or patient demographics (e.g., age or sex). In some embodiments, generating descriptive embeddings may comprise tokenizing descriptive features comprising one or more score feature values associated with one or more of a plurality of scoring identifiers. Sequential ordering embeddings and age/time embeddings may be associated with temporal data associated with encounter data elements. For example, sequential ordering embeddings may be generated from data comprising sequence order between visits to healthcare providers and the length of time between visits, where many recent visits to providers may indicate a new diagnosis or untreated condition. In another example, age/time embeddings may be generated from data comprising age of patient at a particular visit. Encounter number embeddings may be associated with a count of encounter data elements. For example, encounter number embeddings may be generated from data comprising a recent number of visits with a provider (e.g., in the last 6 months) at the time of a specific visit. Locale embeddings may be associated with a setting or location associated with descriptive information (e.g., used to generate descriptive embeddings) of an encounter data element. For example, locale embeddings may be generated from data comprising a type of facility (e.g., inpatient, lab, or clinic) associated with a visit. A code for chest pain recorded in an urgent care facility may have different predictive effect than the same code recorded in an intensive care unit (ICU), and as such, a facility type may be predictive of code severity for at least some codes.

In some embodiments, the term “training embedding” refers to an embedding generated based training data, such as from a pre-training dataset. In some embodiments, one or more initialized weights associated with respective one or more layers of a machine learning model are generated based on a plurality of training embeddings associated with a pre-training dataset.

In some embodiments, the term “input embedding” may refer to an embedding generated based on one or more input encounter data elements associated with an input temporal sequence of encounters data record.

In some embodiments, the term “training data” refers to data used to train a machine learning model to perform a desired prediction task. A machine learning model (and its weights and/or parameters) may be configured to learn (or trained on) features associated with the training data. For example, training data may comprise data including example associations between one or more features and respective one or more labels, wherein the one or more labels comprise expected classifications of the one or more features. In some embodiments, training data may comprise pre-training and fine-tuning datasets. In one example embodiment, machine learning models, such as transformer-based language machine learning models, may be trained on one or more of pre-training and fine-tuning datasets. In some embodiments, training data may be extracted from or generated based on a large corpus of structured data (e.g., electronic health record (EHR)/claims data from electronic medical records (EMR) or databases) comprising a plurality of data fields comprising codes, descriptions of diagnosis or action, times/dates, or other information.

In some embodiments, the term “pre-training dataset” refers to training data used to pre-train a machine learning model (and its weights). A pre-training dataset may comprise a relatively broad-scoped dataset (e.g., than that of a fine-tuning dataset) usable by a machine learning model to learn general functionalities that may help the machine learning model perform a specific prediction task upon fine-tuning (or generating one or more fine-tuned weights by updating one or more initialized weights) of the machine learning model. According to various embodiments of the present disclosure, a machine learning model is pre-trained with a pre-training dataset to predict a next training encounter data element following a sequence of training encounter data elements, such as in a training temporal sequence of encounters data record. In some embodiments, a pre-training dataset comprises structured data from one or more electronic data records or databases comprising one or more data fields associated with codes, descriptions of diagnosis or action, times/dates, or other information. In an example embodiment, a pre-training dataset comprises one or more training temporal sequence of encounters data records comprising training encounter data elements associated with one or more of codes, code types, temporal information, location type information, sequential ordering information, or utilization information.

In some embodiments, the term “pre-training” refers to an initial training of a machine learning model (and its weights), such as a language machine learning model, on a pre-training dataset. A machine learning model may be pre-trained to learn general functionalities that may help the machine learning model perform a specific prediction task that the machine learning model may be fine-tuned to perform. In some embodiments, pre-training may comprise learning from a pre-training dataset by generating one or more initialized weights associated with respective one or more layers of a machine learning model based on a plurality of training embeddings generated based on the pre-training dataset. Though not directly training a machine learning model on a specific prediction task that the machine learning model may be fine-tuned to solve, pre-training may improve the performance of the machine learning model in the specific prediction task by generating initialized weights and/or parameters that are generally applicable to most prediction tasks based on a pre-training dataset. In some embodiments, pre-training a machine learning model (and its one or more weights) comprises masking data in sequences of data and using the machine learning model to predict missing data, where loss may be defined as a difference between actual data and predicted data. A machine learning model may be pre-trained according to one or more pre-training schemes. According to various embodiments of the present disclosure, one or more initialized weights of a machine learning model are pre-trained to (i) determine one or more extra-record encounter data elements in one or more first training temporal sequence of encounters data records from a pre-training dataset and (ii) determine one or more re-ordered encounter data elements in one or more second training temporal sequence of encounters data records from the pre-training dataset. In some embodiments, pre-training a machine learning model to determine an extra-record encounter data element in a first training temporal sequence of encounters data record comprises replacing a sequentially last/next training encounter data element in the first training temporal sequence of encounters data record with a substitute training encounter data element, and determining, using the machine learning model, the substitute training encounter data element as an extra-record encounter data element. In some embodiments, pre-training a machine learning model to determine a re-ordered encounter data element in a second training temporal sequence of encounters data record comprises re-arranging training encounter data elements in the second training temporal sequence of encounters data record, and determining, using the machine learning model, the training encounter data elements have been re-arranged. In another embodiment, pre-training comprises randomly masking one or more training encounter data elements in a training temporal sequence of encounters data record, and training a machine learning model to correctly predict the masked one or more training encounter data elements. In yet another embodiment, pre-training comprises masking a training encounter data element at a given sequential position in a training temporal sequence of encounters data record, where training encounter data elements occurring sequentially before the given sequential position are used as input for predicting the masked training encounter data element.

In some embodiments, the term “encounter data element” refers to a data construct that describes a data element within a temporal sequence of encounters data record. An encounter data element may comprise data associated with codes, descriptions of diagnosis or action, times/dates, or other information. For example, an encounter data element may comprise data representative of an attribute of a patient medical visit (e.g., to a healthcare provider).

In some embodiments, the term “temporal sequence of encounters data record” refers to a data construct that describes a chronological sequence of encounter data elements associated with a given entity. Temporal sequence of encounters data records may be generated or extracted from structured data of one or more electronic records or databases comprising one or more data fields associated with one or more occurrences or events comprising one or more of actions, identifications, observations, determinations, diagnostic results, locations, or time. For example, a temporal sequence of encounters data record may be representative of a history of medical visits made by a given patient comprising a sequence of time-stamped data entries, such as codes or descriptions from an EMR, associated with visitations to one or more healthcare providers.

In some embodiments, the term “entity” refers to a data construct that describes a data object, article, file, program, service, task, operation, computing, and/or the like unit comprising a source, subject, or generator of encounter data elements. An entity may be associated with a real-world object and/or a virtual object.

In some embodiments, the term “extra-record encounter data element” refers to a data construct that describes a training encounter data element that is foreign to or should not belong to a given training temporal sequence of encounters data record. A machine learning model may be pre-trained with respect to the machine learning model's ability to determine a presence of an extra-record encounter data element in a training temporal sequence of encounters data record. For example, a sequentially last/next one of a plurality of training encounter data elements (e.g., representative of a patient's last visit) in a first training temporal sequence of encounters data record (e.g., associated with a first patient) may be selectively (or randomly) replaced with a substitute training encounter data element from a second training temporal sequence of encounters data record (e.g., associated with a second patient). In an alternative example, the substitute training encounter data element from the second training temporal sequence of encounters data record may be selectively (or randomly) inserted as a sequentially last/next one of the plurality of training encounter data elements in the first training temporal sequence of encounters data record. A machine learning model may be pre-trained to classify or determine whether the sequentially last/next training encounter data element is either from the first training temporal sequence of encounters data record, or from another training temporal sequence of encounters data record.

In some embodiments, the term “re-ordered encounter data element” refers to a data construct that describes a training encounter data element that is out of sequential order in a given training temporal sequence of encounters data record. A machine learning model may be pre-trained with respect to the machine learning model's ability to determine a presence of a re-ordered encounter data element in a training temporal sequence of encounters data record. For example, a first training encounter data element in a given training temporal sequence of encounters data record may be selectively (or randomly) re-arranged with a second training encounter data element from the same given training temporal sequence of encounters data record. A machine learning model may be pre-trained to classify or determine a presence of a re-arrangement of training encounter data elements in the given training temporal sequence of encounters data record.

In some embodiments, the term “fine-tuning dataset” refers to training data used to fine-tune a pre-trained machine learning model (and its weights). According to various embodiments of the present disclosure, a pre-trained machine learning model (e.g., pre-trained with pre-training dataset) is fine-tuned using a fine-tuning dataset to perform a specific prediction task. In an example embodiment, a fine-tuning dataset comprises data associated with a target classification.

In some embodiments, the term “fine-tuning” refers to an optimization of a pre-trained machine learning model (and its weights), such as a pre-trained language machine learning model, to perform a specific prediction task associated with a target classification. For example, after a machine learning model has been pre-trained with a pre-training dataset, the machine learning model may be trained on a fine-tuning data set to learn a more specific prediction task. Fine-tuning a machine learning model may comprise adding and/or modifying one or more layers, weights, or parameters of the machine learning model based on a fine-tuning dataset such that the machine learning model is capable of performing specific prediction tasks. That is, fine-tuning may comprise training or modifying (initialized) weights of a pre-trained machine learning model based on a fine-tuning dataset comprising a dataset that is narrower in scope than a pre-training dataset, e.g., specifically relevant to a target classification. Fine-tuning a machine learning model may comprise generating one or more fine-tuned weights by updating one or more initialized weights associated with the machine learning model using a fine-tuning dataset associated with a target classification. The machine learning model may be used to generate one or more prediction scores for one or more prediction encounter data elements associated with the target classification, based on one or more input temporal sequence of encounters data records comprising respective one or more input encounter data elements.

In some embodiments, the term “weight” refers to a data construct that describes a trainable parameter of a machine learning model that transforms input data to output data within a network of hidden layers of a neural network associated with the machine learning model. A machine learning model may comprise one or more weights associated with respective one or more layers of the machine learning model. According to various embodiments of the present disclosure, one or more initialized weights are generated based on a plurality of training embeddings associated with a pre-training dataset. In some embodiments, generating the one or more initialized weights further comprises pre-training the one or more initialized weights according to one or more pre-training schemes. For example, one or more weights of a machine learning model may be pre-trained by (i) determining one or more extra-record encounter data elements in one or more first training temporal sequence of encounters data records from the pre-training dataset, and/or (ii) determining one or more re-ordered encounter data elements in one or more second training temporal sequence of encounters data records from the pre-training dataset. The one or more initialized/pre-trained weights may be further fine-tuned (e.g., generating one or more fine-tuned weight by updating one or more initialized weights) using a fine-tuning dataset associated with a target classification. A machine learning model, based on the one or more initialized weights that are further fine-tuned with the fine-tuning dataset, may be used to generate one or more prediction scores for one or more prediction encounter data elements associated with a target classification.

In some embodiments, the term “layer” refers to a data construct that describes an element, such as a node, in a neural network comprising a machine learning model. A layer may comprise one or more functions and weights usable to transform a data input provided to the layer. The transformed data may comprise a value that may be passed by the layer as an output to be received as data input by a next layer.

In some embodiments, the term “target classification” refers to a data construct that describes an output that a machine learning model is trained to predict (e.g., a specific prediction task). A target classification may be associated with one or more classes a machine learning model is trained to map inputs to. For example, a machine learning model may be trained (or a pre-trained machine learning model may be fine-tuned) to perform a specific prediction task based on a target classification to associate one or more prediction encounter data elements to input data (e.g., one or more input temporal sequence of encounters data records) provided to the machine learning model. In some embodiments, a target classification may be associated with a delineation of types, such as of objects, events, or actions. One or more initialized weights of a machine learning model may be further trained or fine-tuned (e.g., generating one or more fine-tuned weights by updating one or more initialized weights) based on a target classification such that the machine learning model may generate predictions with respect to the target classification. In one example embodiment, a machine learning model is trained based on a target classification to predict one or more of an onset of a diagnosis, event, or response to actions/treatments. According to various embodiments of the present disclosure, one or more pre-trained/initialized weights (e.g., based on a pre-training dataset) of a machine learning model are fine-tuned using a fine-tuning dataset associated with a target classification. As such, one or more prediction scores for one or more prediction encounter data elements associated with the target classification may be generated using the machine learning model.

In some embodiments, the term “prediction score” refers to a data construct that describes a numerical value representative of a probability of a prediction associated with a target classification. One or more prediction scores may be generated by a machine learning model (e.g., that is pre-trained and fine-tuned to perform a specific prediction task based on the target classification).

In some embodiments, the term “machine learning model” refers to a data construct that describes parameters, hyperparameters, and/or defined operations of a machine learning model configured to perform a specific prediction task associated with a target classification. In particular, the specific prediction task may comprise generating one or more prediction scores for one or more prediction encounter data elements associated with the target classification, based on one or more input temporal sequence of encounters data records comprising respective one or more input encounter data elements. In some embodiments, a machine learning model may comprise one or more initialized weights, associated with respective one or more layers of the machine learning model, that are generated by pre-training based on a plurality of training embeddings associated with a pre-training dataset. According to various embodiments of the present disclosure, one or more initialized weights of a machine learning model are pre-trained by (i) determining one or more extra-record encounter data elements in one or more first training temporal sequence of encounters data records from the pre-training dataset and (ii) determining one or more re-ordered encounter data elements in one or more second training temporal sequence of encounters data records from the pre-training dataset. The one or more pre-trained/initialized weights of the machine learning model may be further fine-tuned (e.g., generating one or more fine-tuned weights by updating one or more initialized weights) using a fine-tuning dataset associated with a target classification. In some embodiments, the machine learning model comprises a large language model (LLM) with a transformer-based machine learning model architecture. In some embodiments, the machine learning model comprises a plurality of transformer layers, wherein each of the plurality of transformer layers comprises self-attention (e.g., an attention mechanism that learns contextual relations between words, letters, numbers, signs, or any combination thereof, in a text) and a feedforward network.

In some embodiments, the term “tokenize” or “tokenization” refers to an operation that converts data into a token by using a mapping based on an index of predefined values. For example, training encounter data elements comprising one or more score feature values may be represented as tokens categorizing and scaling the one or more score feature values to specific tokens based on a tokenization scheme. In some embodiments, generating a plurality of training embeddings based on a pre-training dataset may comprise tokenizing at least a portion of the pre-training dataset comprising one or more score feature values associated with one or more training encounter data elements. For example, the pre-training dataset may comprise one or more score feature values associated with one or more of a plurality of scoring identifiers, such as test/diagnostic results, where the one or more score feature values may vary in range based on source of the one or more score feature values. In some embodiments, tokenizing one or more score feature values may comprise determining deciles of score feature values from a variety of sources (e.g., claims data, EHR) of the one or more score feature values and using the deciles to create a common set of ranges for each of the plurality of scoring identifiers. An exponential function may be fitted using decile max values of the determined deciles to determine an estimate of an overall max value for each scoring identifier, and score feature values outside of the decile max values may be filtered. According to various embodiments of the present disclosure, at least a portion of a pre-training dataset comprising one or more pre-training score feature values associated with one or more training encounter data elements is tokenized by (i) generating a plurality of deciles based on a plurality of score feature values, (ii) determining a plurality of maximum decile values associated with the plurality of deciles, (iii) determining a maximum score feature value for each of a plurality of scoring identifiers associated with the plurality of score feature values based on an exponential function comprising the plurality of maximum decile values, and (iv) assigning one or more pre-training score feature values to one or more of the plurality of deciles based on the plurality of maximum decile values and the maximum score feature value.

In some embodiments, the term “token” refers to a data construct that describes a representation of at least a portion of a training encounter data element from a pre-training dataset as a unique identifier comprising one or more integers and/or characters. For example, a token may be formatted according to one or more integer values, binary values, or hexadecimal values.

### IV. OVERVIEW

Various embodiments of the present disclosure make important technical contributions to improving predictive accuracy of a predictive machine learning model comprising a language machine learning model by generating training embeddings associated with data fields of structured data used for pre-training and fine-tuning the language machine learning model. This approach improves training speed and training efficiency of training predictive machine learning models. It is well-understood in the relevant art that there is typically a tradeoff between predictive accuracy and training speed, such that it is trivial to improve training speed by reducing predictive accuracy. Thus, the challenge is to improve training speed without sacrificing predictive accuracy through innovative model architectures. Accordingly, techniques that improve predictive accuracy without harming training speed, such as the techniques described herein, enable improving training speed given a constant predictive accuracy. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training machine learning models.

For example, various embodiments of the present disclosure improve predictive accuracy of predictive machine learning models by generating training embeddings associated with data fields of structured data used for pre-training and fine-tuning the language machine learning model. Using some of the techniques of the present disclosure, an LLM may be modified to allow the LLM to handle types of data that are not traditionally handled by LLMs, such as structured medical claims and EHR, which may comprise diagnosis (e.g., ICD) codes, billing procedure (e.g., CPT) codes, prescriptions, lab results, patient demographics and other information organized according to different interactions with a healthcare system occurring at a specific date/time. According to various embodiments of the present disclosure, a pre-training task, such as predicting masked codes during specific provider visits, may be performed to allow a language machine learning model to be applied to a large corpus of structured medical data to compensate for a reduced amount of data that may be available for a target prediction problem that the language machine learning model is fine-tuned to solve (e.g., diabetes, readmission, or drug response prediction). In an example embodiment, a language machine learning model is trained to perform a range of disease prediction tasks, such as estimating a probability that an individual will receive a particular diagnosis, an existing disease will progress to a more advanced state, or another medical event will occur (e.g., readmission to a hospital).

In accordance with various embodiments of the present disclosure, a predictive machine learning model may comprise a language machine learning model configured to process structured data via a plurality of training embeddings associated with a plurality of data types. Accordingly, configuring the language machine learning model with the plurality of training embeddings may allow the language machine learning model to handle types of data, other than text/language, that are not traditionally handled by a language machine learning model, such as data in data fields of structured data from databases or electronic record systems comprising codes, descriptions of diagnosis or action, times/dates, or other information. In this manner, some of the techniques of the present disclosure, improve accuracy of performing predictive operations as needed on certain sets of data. In doing so, some of the techniques described herein may improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training predictive machine learning models. Other technical improvements and advantages may be realized by one of ordinary skill in the art.

### V. EXAMPLE SYSTEM OPERATIONS

As indicated, various embodiments of the present disclosure make important technical contributions to improving predictive accuracy of a predictive machine learning model comprising a language machine learning model by generating training embeddings associated with data fields of structured data used for pre-training and fine-tuning the language machine learning model. This approach improves training speed and training efficiency of training predictive machine learning models. It is well-understood in the relevant art that there is typically a tradeoff between predictive accuracy and training speed, such that it is trivial to improve training speed by reducing predictive accuracy. Thus, the challenge is to improve training speed without sacrificing predictive accuracy through innovative model architectures. Accordingly, techniques that improve predictive accuracy without harming training speed, such as the techniques described herein, enable improving training speed given a constant predictive accuracy. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training machine learning models.

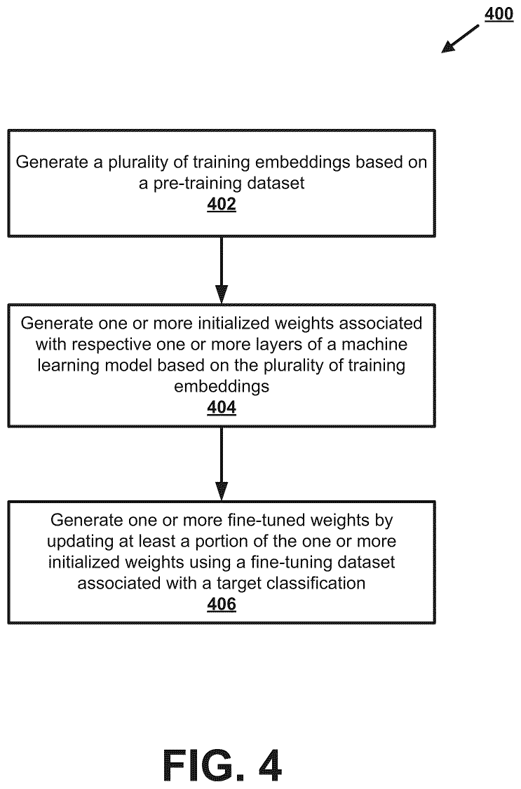

FIG. 4 is a flowchart diagram of an example process 400 for training a machine learning model in accordance with some embodiments discussed herein. In some embodiments, via the various steps/operations of the process 400, the predictive data analysis computing entity 106 may use a plurality of training embeddings based on a pre-training dataset to pre-train a machine learning model and fine-tune the machine learning model using a fine-tuning dataset.

In some embodiments, the process 400 begins at step/operation 402 when the predictive data analysis computing entity 106 generates a plurality of training embeddings based on a pre-training dataset. In some embodiments, a training embedding describes a latent representation of data comprising one or more features. For example, a training embedding may be expressed as a vector comprising one or more numbers representative of one or more features associated with content of training data. In some embodiments, a training embedding may be generated by mapping one or more features to one or more elements in a vector space. According to various embodiments of the present disclosure, the data an embedding represents comprises a feature associated with machine learning model input or training data, such as of a temporal sequence of encounters data record or an input encounter data element of the temporal sequence of encounters data record. One or more training embeddings may be generated for machine learning model training data such that the machine learning model training data may be provided in a format suitable for analysis or processing by a machine learning model, such as a language machine learning model. In some embodiments, one or more training embeddings are generated from training data based on respective one or more types of information in the data. In some embodiments, one or more initialized weights associated with respective one or more layers of a machine learning model are generated based on a plurality of training embeddings associated with a pre-training dataset.

According to various embodiments of the present disclosure, the plurality of training embeddings is generated such that a machine learning model, such as a transformer-based language machine learning model, may be able to interpret a variety of data types and extend the machine learning model's prediction capabilities to such data types. For example, training embeddings may be generated for a language machine learning model such that the language machine learning model may be trained on data from electronic records or databases (e.g., EMRs or medical claims databases).

In some embodiments, a variety of embeddings are generated based on respective one or more types of information represented in the pre-training dataset. For example, embeddings may be generated based on features comprised in training temporal sequence of encounters data record and associated training encounter data elements in the pre-training dataset. According to various embodiments of the present disclosure, the plurality of training embeddings comprises one or more of descriptive embeddings, sequential ordering embeddings, age/time embeddings, locale embeddings, or encounter number embeddings. Descriptive embeddings may be associated with descriptive features associated with training encounter data elements of temporal sequence of encounters data records. For example, descriptive embeddings may be generated from data comprising diagnosis codes (e.g., International Classification of Diseases (ICD) codes), procedure codes (e.g., Current Procedural Terminology (CPT) codes), medications (e.g., generic names), lab results (e.g., Logical Observation Identifiers, Names and Codes (LOINC) codes), or patient demographics (e.g., age or sex). Sequential ordering embeddings and age/time embeddings may be associated with temporal data associated with training encounter data elements. For example, sequential ordering embeddings may be generated from data comprising sequence order between visits to healthcare providers and the length of time between visits, where many recent visits to providers may indicate a new diagnosis or untreated condition. In another example, age/time embeddings may be generated from data comprising age of patient at a particular visit. Encounter number embeddings may be associated with a count of training encounter data elements. For example, encounter number embeddings may be generated from data comprising a recent number of visits with a provider (e.g., in the last 6 months) at the time of a specific visit. Locale embeddings may be associated with a setting or location associated with descriptive information (e.g., used to generate descriptive embeddings) of a training encounter data element. For example, locale embeddings may be generated from data comprising a type of facility (e.g., inpatient, lab, or clinic) associated with a visit. A code for chest pain recorded in an urgent care facility may have different predictive effect than the same code recorded in an intensive care unit (ICU), and as such, a facility type may be predictive of code severity for at least some codes.

In some embodiments, a pre-training dataset describes training data used to pre-train a machine learning model (and its weights). A pre-training dataset may comprise a relatively broad-scoped dataset (e.g., than that of a fine-tuning dataset) usable by a machine learning model to learn general functionalities that may help the machine learning model perform a specific prediction task upon fine-tuning of the machine learning model. According to various embodiments of the present disclosure, a machine learning model is pre-trained with a pre-training dataset to predict a next/last training encounter data element following a sequence of training encounter data elements, such as in a training temporal sequence of encounters data record. In some embodiments, a pre-training dataset comprises structured data from one or more electronic data records or databases comprising one or more data fields associated with codes, descriptions of diagnosis or action, times/dates, or other information. In an example embodiment, a pre-training dataset comprises one or more training temporal sequence of encounters data records comprising training encounter data elements associated with one or more of codes, code types, temporal information, location type information, sequential ordering information, or utilization information.

In some embodiments, an encounter data element describes a data element within a temporal sequence of encounters data record. An encounter data element may comprise data associated with codes, descriptions of diagnosis or action, times/dates, or other information. For example, an encounter data element may comprise data representative of an attribute of a patient medical visit (e.g., to a healthcare provider). In one example embodiment, an encounter data element comprises one or more codes, such as diagnosis codes, procedure codes, pharmacy codes, or lab results. Words and phrases associated with the codes may also be mapped to respective codes. In a further example embodiment, an encounter data element comprises one or more of code types (e.g., diagnosis codes, procedure codes, and pharmacy codes), temporal information (e.g., a date on which a code was entered into an EMR), location type information (e.g., types of treatment facilities such as hospitals, emergency departments, intensive care units, skilled nursing facilities, urgent care facilities, and other types of clinics, or labels for facilities that specialize in different types of care), sequential ordering information (e.g., a number specifying the sequential order in which it was entered into the patient's record), patient demographics (e.g., age, sex, or ethnicity), or healthcare system utilization information.

In some embodiments, a temporal sequence of encounters data record describes a chronological sequence of encounter data elements associated with a given entity. Temporal sequence of encounters data records may be generated or extracted from structured data of one or more electronic records or databases comprising one or more data fields associated with one or more occurrences or events comprising one or more of actions, identifications, observations, determinations, diagnostic results, locations, or time. For example, a temporal sequence of encounters data record may be representative of a history of medical visits made by a given patient comprising a sequence of time-stamped data entries, such as codes or descriptions from an EMR, associated with visitations to one or more healthcare providers.

In some embodiments, an entity describes a data object, article, file, program, service, task, operation, computing, and/or the like unit comprising a source, subject, or generator of encounter data elements. An entity may be associated with a real-world object and/or a virtual object.

As described herein, in accordance with various embodiments of the present disclosure, a predictive machine learning model may comprise a language machine learning model configured to process structured data via a plurality of training embeddings associated with a plurality of data types. Accordingly, configuring the language machine learning model with the plurality of training embeddings may allow the language machine learning model to handle types of data, other than text/language, that are not traditionally handled by a language machine learning model, such as data in data fields of structured data from databases or electronic record systems comprising codes, descriptions of diagnosis or action, times/dates, or other information. This technique will lead to higher accuracy of performing predictive operations as needed on certain sets of data. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training predictive machine learning models.

In some embodiments, generating a plurality of training embeddings further comprises tokenizing one or more training encounter data elements comprising one or more score feature values associated with one or more of a plurality of scoring identifiers. In some embodiments, tokenizing the one or more training encounter data elements comprises an operation that converts the one or more score feature values into one or more respective tokens by using a mapping based part on an index of predefined values. For example, training encounter data elements comprising one or more score feature values may be represented as tokens categorizing and scaling the one or more score feature values to specific tokens based on a tokenization scheme. In some embodiments, a token describes a representation of at least a portion of a training encounter data element from a pre-training dataset as a unique identifier comprising one or more integers and/or characters. For example, a token may be formatted according to one or more integer values, binary values, or hexadecimal values.

In some embodiments, generating a plurality of training embeddings based on a pre-training dataset may comprise tokenizing at least a portion of the pre-training dataset comprising one or more score feature values associated with one or more training encounter data elements. For example, the pre-training dataset may comprise one or more score feature values associated with one or more of a plurality of scoring identifiers, such as test/diagnostic results, where the one or more score feature values may vary in range based on source of the one or more score feature values. Tokenizing the one or more score feature values may comprise binning the one or more score feature values using deciles or any set of percentiles, such as quartiles or quintiles. In some embodiments, tokenizing the one or more score feature values comprises determining deciles of score feature values from a variety of sources (e.g., claims data, EHR) of the one or more score feature values and using the deciles to create a common set of ranges for each of the plurality of scoring identifiers. An exponential function may be fitted using decile max values of the determined deciles to determine an estimate of an overall max value for each scoring identifier, and score feature values outside of the decile max values may be filtered. In other embodiments, tokenizing the one or more score feature values comprises binning the one or more score feature values based on categorical/gradual bins. For example, the binning of score feature values associated with medical laboratory results may be done using clinically relevant bins; for example, LOINC HbA1C may associate values less than 6.0 with a normal bin, less than 6.5 but greater than 6.0 with a pre-diabetic bin, values greater than 6.5 but less than 7.0 with a mildly diabetic bin, and values greater than 7.0 with a severely diabetic bin.

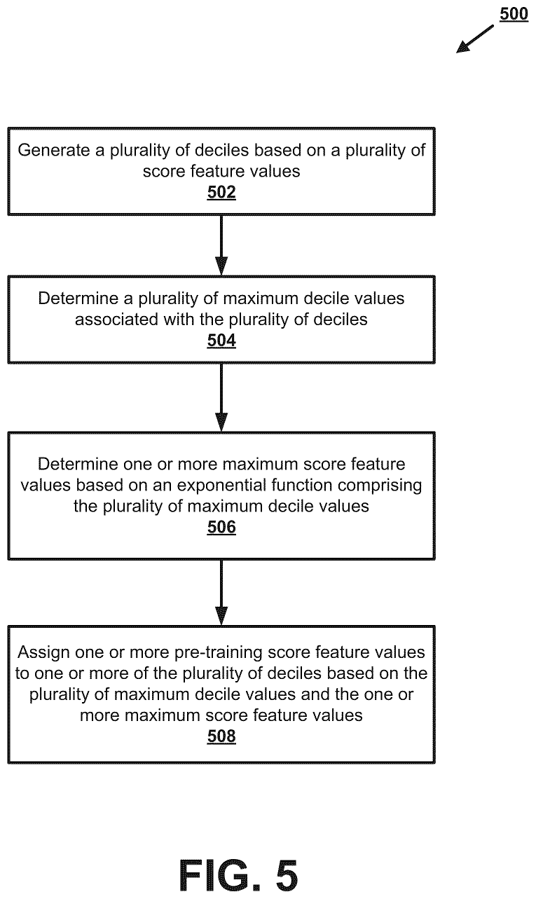

FIG. 5 is a flowchart diagram of an example process 500 for tokenizing at least a portion of a pre-training dataset in accordance with some embodiments discussed herein. In some embodiments, via the various steps/operations of the process 500, the predictive data analysis computing entity 106 performs discrete binning or data bucketing of the one or more pre-training score feature values based on deciles. The one or more pre-training score feature values may be assigned to a plurality of decile-based bins and the one or more pre-training score feature values may be replaced with respective values representative of the decile-based bins the one or more pre-training score feature values have been assigned to.

In some embodiments, the process 500 begins at step/operation 502 when the predictive data analysis computing entity 106 generates a plurality of deciles based on a plurality of score feature values. The plurality of score feature values may be associated with a plurality of scoring identifiers and generated by or retrieved from a variety of sources. In some embodiments, a decile describes a division of a dataset into ten subsets. As such, generating the plurality of deciles may comprise generating a set of deciles (e.g., ten) for each scoring identifier. In some embodiments, a scoring identifier describes words, letters, numbers, signs, and/or any combination thereof, used to represent a set of processes or procedures that generates a result or score. For example, a scoring identifier may comprise a name or code of a test or diagnostic. In an example embodiment, a scoring identifier comprises a Logical Observation Identifiers Names and Codes (LOINC) code.

In some embodiments, generating the plurality of deciles may further comprise filtering or selecting a plurality of score feature values comprising scoring identifiers associated with a threshold amount of observations (e.g., score feature values) for generating the plurality of deciles. For example, scores associated with scoring identifiers of tests or diagnostics with at least a minimum number of observations out of a total number of observations from a dataset of tests or diagnostics may be selected for generating deciles.

In some embodiments, at step/operation 504, the predictive data analysis computing entity 106 determines a plurality of maximum decile values associated with the plurality of deciles. In some embodiments, determining the plurality of maximum decile values comprises determining for each scoring identifier, a plurality of decile values (e.g., nine) based on score feature values from the plurality of score feature values comprising the scoring identifier. A decile value may comprise one of nine values dividing the score feature values from the plurality of score feature values comprising the scoring identifier into ten groups. In some embodiments, score feature values associated with a scoring identifier comprising a maximum decile value of zero for a specific decile (e.g., third) may be culled.

In some embodiments, at step/operation 506, the predictive data analysis computing entity 106 determines one or more maximum score feature values for respective one or more of a plurality of scoring identifiers associated with the plurality of score feature values based on an exponential function comprising respective ones of the plurality of maximum decile values. For each scoring identifier, an exponential function may be fitted with maximum decile values of the first nine deciles associated with the scoring identifier to determine a tenth decile based on the exponential function. The tenth decile may be an estimate or representative of an overall maximum value for the scoring identifier.

In some embodiments, at step/operation 508, the predictive data analysis computing entity 106 assigns one or more pre-training score feature values to one or more of the plurality of deciles based on the plurality of maximum decile values and the one or more maximum score feature values. The one or more pre-training score feature values may comprise score feature values comprising at least a portion of a pre-training dataset. The plurality of maximum decile values along with the one or more maximum score feature values may be used to establish a set of ranges associated with a set of deciles for each of the plurality of scoring identifiers. For example, a pre-training score feature value comprising a LOINC code of “4548-4” with a “HbA1C” scoring identifier may be tokenized as “4548-4-1” for values between 5.3 and 5.5, and “4548-4-2” for values between 5.5 to 5.7, and follows a similar pattern for higher values. Pre-training score feature values that are outside of the ranges may be removed or omitted for tokenization, such as pre-training score feature values that are greater than the respective one or more maximum score feature values (e.g., three times greater).

Referring back to FIG. 4, in some embodiments, at step/operation 404, the predictive data analysis computing entity 106 generates one or more initialized weights associated with respective one or more layers of a machine learning model based on the plurality of training embeddings.

In some embodiments, a weight describes a trainable parameter of a machine learning model that transforms input data to output data within a network of hidden layers of a neural network associated with the machine learning model. A machine learning model may comprise one or more weights associated with respective one or more layers of the machine learning model. According to various embodiments of the present disclosure, one or more initialized weights are generated based on a plurality of training embeddings associated with a pre-training dataset. In some embodiments, generating the one or more initialized weights further comprises pre-training the one or more initialized weights according to one or more pre-training schemes. The one or more initialized/pre-trained weights may be further fine-tuned (e.g., generating one or more fine-tuned weights by updating one or more initialized weights) using a fine-tuning dataset associated with a target classification. A machine learning model, based on the one or more weights fine-tuned with the fine-tuning dataset, may be used to generate one or more prediction scores for one or more prediction encounter data elements associated with a target classification.

In some embodiments, a layer describes an element, such as a node, in a neural network comprising a machine learning model. A layer may comprise one or more functions and weights usable to transform a data input provided to the layer. The transformed data may comprise a value that may be passed by the layer as an output to be received as data input by a next layer.

In some embodiments, a machine learning model describes parameters, hyperparameters, and/or defined operations of a machine learning model that is configured to perform a specific prediction task associated with a target classification. In particular, the specific prediction task may comprise generating one or more prediction scores for one or more prediction encounter data elements associated with the target classification, based on one or more input temporal sequence of encounters data records comprising respective one or more input encounter data elements. In some embodiments, a machine learning model may comprise one or more initialized weights, associated with respective one or more layers of the machine learning model, that are generated by pre-training based on a plurality of training embeddings associated with a pre-training dataset. The one or more pre-trained/initialized weights of the machine learning model may be further fine-tuned (e.g., generating one or more fine-tuned weights by updating one or more initialized weights) using a fine-tuning dataset associated with a target classification. In some embodiments, the machine learning model comprises a large language model (LLM) with a transformer-based machine learning model architecture. In some embodiments, the machine learning model comprises a plurality of transformer layers, wherein each of the plurality of transformer layers comprises self-attention (e.g., an attention mechanism that learns contextual relations between words, letters, numbers, signs, or any combination thereof, in a text) and a feedforward network.

Accordingly, in some embodiments, via performing step/operation 404, the predictive data analysis computing entity 106 generates one or more initialized weights of a machine learning model as a result of learning from the plurality of training embeddings and by pre-training the machine learning model.

In some embodiments, pre-training describes an initial training of a machine learning model (and its weights), such as a language machine learning model, on a pre-training dataset. A machine learning model may be pre-trained to learn general functionalities that may help the machine learning model perform a specific prediction task that the machine learning model may be fine-tuned to perform. In some embodiments, pre-training may comprise learning from a pre-training dataset by generating one or more initialized weights associated with respective one or more layers of a machine learning model based on a plurality of training embeddings generated based on the pre-training dataset. Though not directly training a machine learning model on a specific prediction task that the machine learning model may be fine-tuned to solve, pre-training may improve the performance of the machine learning model in the specific prediction task by initializing weights and/or parameters that are generally applicable to most prediction tasks based on a pre-training dataset. In some embodiments, pre-training a machine learning model (and its one or more weights) comprises masking data in sequences of data and using the machine learning model to predict missing data, where loss may be defined as a difference between actual data and predicted data. A machine learning model may be pre-trained according to one or more pre-training schemes.

According to various embodiments of the present disclosure, one or more initialized weights of a machine learning model are pre-trained to (i) determine one or more extra-record encounter data elements in one or more first training temporal sequence of encounters data records from a pre-training dataset and (ii) determine one or more re-ordered encounter data elements in one or more second training temporal sequence of encounters data records from the pre-training dataset.

In some embodiments, pre-training a machine learning model to determine an extra-record encounter data element in a training temporal sequence of encounters data record comprises replacing a sequentially last/next training encounter data element in the training temporal sequence of encounters data record with a substitute training encounter data element, and determining, using the machine learning model, the substitute training encounter data element as an extra-record encounter data element.

In some embodiments, an extra-record encounter data element describes a training encounter data element that is foreign to or should not belong to a given training temporal sequence of encounters data record. A machine learning model may be pre-trained with respect to the machine learning model's ability to determine a presence of an extra-record encounter data element in a training temporal sequence of encounters data record. For example, a sequentially last/next one of a plurality of training encounter data elements (e.g., representative of a patient's last visit) in a first training temporal sequence of encounters data record (e.g., associated with a first patient) may be selectively (or randomly) replaced with a substitute training encounter data element from a second training temporal sequence of encounters data record (e.g., associated with a second patient). In an alternative example, the substitute training encounter data element from the second training temporal sequence of encounters data record may be selectively (or randomly) inserted as a sequentially last/next one of the plurality of training encounter data elements in the first training temporal sequence of encounters data record. A machine learning model may be pre-trained by classifying or determining whether the sequentially last/next training encounter data element is either from the first training temporal sequence of encounters data record, or from another training temporal sequence of encounters data record.

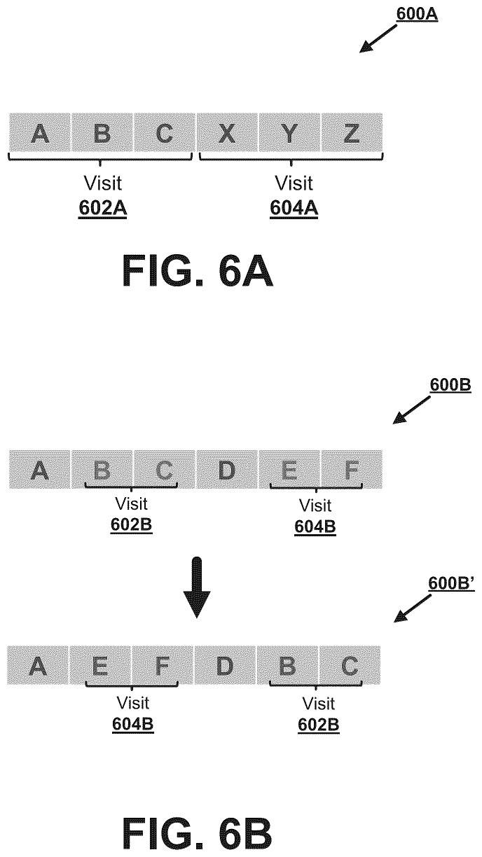

FIG. 6A provides an operational example of next encounter prediction pre-training in accordance with some embodiments discussed herein. As depicted in FIG. 6A, a training temporal sequence of encounters data record 600A comprises training encounter data elements “A,” “B,” and “C” associated with a visit 602A that correctly belong to the training temporal sequence of encounters data record 600A. Training temporal sequence of encounters data record 600A also comprises training encounter data elements “X,” “Y,” and “Z” associated with a visit 604A. Training encounter data elements “X,” “Y,” and “Z” of visit 604A are sequentially inserted after training encounter data elements “A,” “B,” and “C” of visit 602A, and thus, visit 604A represents training encounter data elements occurring temporally after visit 602A. In the depicted embodiment, visit 604A has been inserted from another training temporal sequence of encounters data record into training temporal sequence of encounters data record 600A. As such, a machine learning model may be pre-trained to correctly determine or predict whether visit 604A should belong in training temporal sequence of encounters data record 600A.

In some embodiments, pre-training a machine learning model to determine one or more re-ordered encounter data elements in one or more second training temporal sequence of encounters data records comprises re-arranging one or more training encounter data elements in at least one of the one or more second training temporal sequence of encounters data records, and determining, using the machine learning model, the one or more training encounter data elements have been re-arranged.

In some embodiments, a re-ordered encounter data element describes a training encounter data element that is out of sequential order in a given training temporal sequence of encounters data record. A machine learning model may be pre-trained with respect to the machine learning model's ability to determine a presence of a re-ordered encounter data element in a pre-training temporal sequence of encounters data record. For example, a first training encounter data element in a given training temporal sequence of encounters data record may be selectively (or randomly) re-arranged with a second training encounter data element from the same given training temporal sequence of encounters data record. A machine learning model may be pre-trained by classifying or determining a presence of a re-arrangement of training encounter data elements in the given training temporal sequence of encounters data record.

FIG. 6B provides an operational example of encounter swap prediction pre-training in accordance with some embodiments discussed herein. As depicted in FIG. 6B, a training temporal sequence of encounters data record 600B comprises training encounter data elements “B” and “C” associated with a visit 602B and training encounter data elements “E” and “F” associated with a visit 604B. In the depicted embodiment, training encounter data elements “E” and “F” of visit 604B are sequentially positioned after training encounter data elements “B” and “C” of visit 602B in training temporal sequence of encounters data record 600B, and thus, visit 604B represents training encounter data elements occurring temporally after visit 602B. According to various embodiments of the present disclosure, visit 602B and visit 604B may be swapped such that training encounter data elements “E” and “F” of visit 604B are sequentially positioned before training encounter data elements “B” and “C” of visit 602B, thereby generating a training temporal sequence of encounters data record 600B′. A machine learning model may be pre-trained to correctly determine or predict whether visit 602B and visit 604B have been swapped in training temporal sequence of encounters data record 600B′.

In another embodiment, pre-training comprises randomly masking one or more training encounter data elements in a training temporal sequence of encounters data record, and training a machine learning model to correctly predict the masked one or more training encounter data elements. In yet another embodiment, pre-training comprises masking a training encounter data element at a given sequential position in a training temporal sequence of encounters data record, where training encounter data elements occurring sequentially before the given sequential position are used as input for predicting the masked training encounter data element.

Referring back to FIG. 4, in some embodiments, at step/operation 406, the predictive data analysis computing entity 106 generates one or more fine-tuned weights by updating at least a portion of the one or more initialized weights using a fine-tuning dataset associated with a target classification. In some embodiments, fine-tuning describes an optimization of a pre-trained machine learning model (and its weights), such as a pre-trained language machine learning model, to perform a specific prediction task associated with a target classification. For example, after a machine learning model has been pre-trained with a pre-training dataset, the machine learning model may be trained on a fine-tuning data set to learn a more specific prediction task. Fine-tuning a machine learning model may comprise adding and/or modifying one or more layers, weights, or parameters of the machine learning model based on a fine-tuning dataset such that the machine learning model is capable of performing specific prediction tasks. That is, fine-tuning may comprise training or modifying (initialized) weights of a pre-trained machine learning model based on a fine-tuning dataset comprising a dataset that is narrower in scope than a pre-training dataset, e.g., specifically relevant to a target classification. The machine learning model may be used to generate one or more prediction scores for one or more prediction encounter data elements associated with the target classification, based on one or more input temporal sequence of encounters data records comprising respective one or more input encounter data elements.

In some embodiments, a fine-tuning dataset describes training data used to fine-tune a pre-trained machine learning model (and its weights). According to various embodiments of the present disclosure, a pre-trained machine learning model (e.g., pre-trained with pre-training dataset) is fine-tuned using a fine-tuning dataset to perform a specific prediction task. In an example embodiment, a fine-tuning dataset comprises data associated with a target classification.

In some embodiments, a target classification describes an output that a machine learning model is trained to predict (e.g., a specific prediction task). A target classification may be associated with one or more classes a machine learning model is trained to map inputs to. For example, a machine learning model may be trained (or a pre-trained machine learning model may be fine-tuned) to perform a specific prediction task based on a target classification to associate one or more prediction encounter data elements to input data (e.g., one or more input temporal sequence of encounters data records) provided to the machine learning model. In some embodiments, a target classification may be associated with a delineation of types, such as of objects, events, or actions. One or more initialized weights of a machine learning model may be further trained or fine-tuned (e.g., generating one or more fine-tuned weights by updating one or more initialized weights) based on a target classification such that the machine learning model may generate predictions with respect to the target classification. In one example embodiment, a machine learning model is trained based on a target classification to predict one or more of an onset of a diagnosis, event, or response to actions/treatments. According to various embodiments of the present disclosure, one or more pre-trained/initialized weights (e.g., based on a pre-training dataset) of a machine learning model are fine-tuned using a fine-tuning dataset associated with a target classification. As such, one or more prediction scores for one or more prediction encounter data elements associated with the target classification may be generated using the machine learning model. In one example embodiment, a machine learning model is fine-tuned using a fine-tuning dataset comprising a subset of EMR records specific to a particular disease type or other event of interest, and as such, the machine learning model and its one or more (initialized) weights may be fine-tuned to perform a classification associated with the particular disease type or other event of interest (e.g., diabetes, readmission, or drug response prediction).

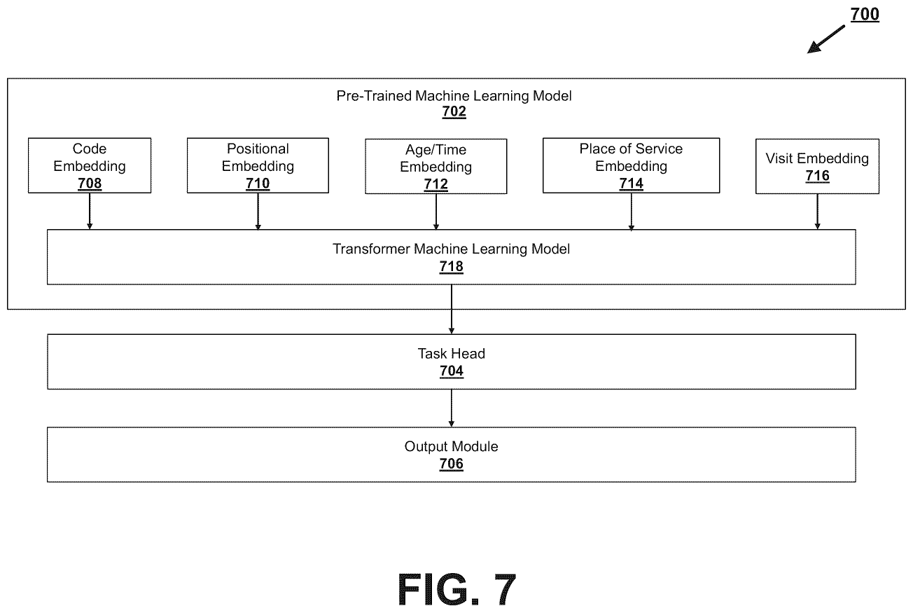

In some embodiments, the predictive data analysis computing entity comprises a machine learning model framework 700 with the architecture depicted in FIG. 7. FIG. 7 provides an operational example of a machine learning model framework 700 in accordance with some embodiments discussed herein. As depicted in FIG. 7, the machine learning model framework 700 comprises a pre-trained machine learning model 702, a task head 704, and an output module 706. Although the machine learning model framework 700 depicted in FIG. 7 is described in the context of being used for healthcare data, machine learning model framework 700 may customized to any domain, such as banking, industrial, manufacturing, education, retail.

The pre-trained machine learning model 702 may receive training data, such as a pre-training dataset comprising training temporal sequence of encounters data records based on EMR records and claims data. The training temporal sequence of encounters data records may comprise one or more training encounter data elements of which a plurality of training embeddings comprising code embedding 708, positional embedding 710, age/time embedding 712, place of service embedding 714, and visit embedding 716 may be generated from. The plurality of training embeddings may be representative of features extracted from the training encounter data elements that may be provided to transformer machine learning model 718 to train on and/or learn from.

In some embodiments, transformer machine learning model 718 may be pre-trained using the code embedding 708, positional embedding 710, age/time embedding 712, place of service embedding 714, and visit embedding 716. Code embedding 708 may be representative of data comprising clinical codes and demographics. Positional embedding 710 may be representative of data comprising sequencing in clinical history. Age/time embedding 712 may be representative of data comprising patient age and/or number of visits in a period of time (e.g., last six months, or a year). Place of service embedding 714 may be representative of data comprising care setting. Visit embedding 716 may be representative of data comprising visit number in clinical history.

Transformer machine learning model 718 may comprise an LLM with a transformer-based machine learning model architecture. In some embodiments, the machine learning model comprises a plurality of transformer layers, wherein each of the plurality of transformer layers comprises self-attention (e.g., an attention mechanism that learns contextual relations between words, letters, numbers, signs, or any combination thereof, in a text) and a feedforward network. The transformer machine learning model 718 may generate one or more initialized weights and generate one or more parameters such that the transformer machine learning model 718 is capable of performing a generic classification task based on the code embedding 708, positional embedding 710, age/time embedding 712, place of service embedding 714, and visit embedding 716 generated from a pre-training dataset.

Task head 704 may comprise one or more task-specific layers and associated weights of transformer machine learning model 718 that may be fine-tuned using a fine-tuning dataset associated with a target classification such that task head 704 may be configured to generate a final prediction task with respect to the target classification. In some embodiments, the final prediction task may comprise generating one or more prediction scores for one or more prediction encounter data elements associated with the target classification.

For example, task head 704 may (i) receive a prediction input comprising one or more input temporal sequence of encounters data records comprising respective one or more input encounter data elements and (ii) for each of the one or more input temporal sequence of encounters data records, generate one or more prediction scores for one or more prediction encounter data elements associated with the target classification, wherein the one or more prediction encounter data elements are representative of encounter data elements that may be likely added sequentially next to existing one or more input encounter data elements of the input temporal sequence of encounters data record at a future time.

Output module 706 may be configured to receive the one or more prediction scores generated by task head 704 and generate a binary classification of one or more prediction encounter data elements. For example, output module 706 may generate a classification comprising whether an input temporal sequence of encounters data record will include one or more prediction encounter data elements within a given time in the future.

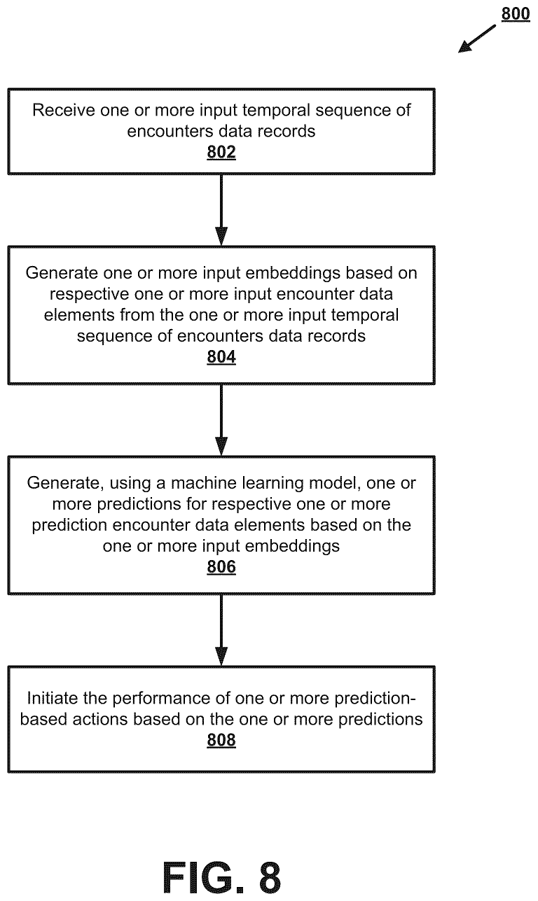

FIG. 8 is a flowchart diagram of an example process 800 for performing predictive operations in accordance with some embodiments discussed herein. In some embodiments, the process 800 begins at step/operation 802 when the predictive data analysis computing entity 106 receives one or more input temporal sequence of encounters data records. The one or more input temporal sequence of encounter data records may be provided to predictive data analysis computing entity 106 as a basis for generating respective one or more predictions on. The one or more input temporal sequence of encounters data records may be generated or extracted from structured data of one or more electronic data records or databases comprising one or more data fields associated with one or more occurrences or events comprising one or more of actions, identifications, observations, determinations, diagnostic results, locations, or time. In some embodiments, the one or more input temporal sequence of encounters data records comprise one or more patient medical records. In some embodiments, each of the one or more input temporal sequence of encounters data record comprises one or more input encounter data elements. The one or more input encounter data elements may comprise data associated with codes, descriptions of diagnosis or action, times/dates, or other information. For example, an encounter data element may comprise data representative of an attribute of a patient medical visit (e.g., to a healthcare provider).

In some embodiments, at step/operation 804, the predictive data analysis computing entity 106 generates one or more input embeddings based on respective one or more input encounter data elements from the one or more input temporal sequence of encounters data records. The one or more input embeddings may comprise latent representations of features associated with the one or more input encounter data elements (e.g., codes, descriptions of diagnosis or action, times/dates, or other information). As such, generating the one or more input embeddings may comprise generating one or more of descriptive embeddings, sequential ordering embeddings, age/time embeddings, locale embeddings, or encounter number embeddings based on the type of feature associated with the one or more input encounter data elements.

In some embodiments, at step/operation 806, the predictive data analysis computing entity 106 generates, using a machine learning model, one or more predictions for respective one or more prediction encounter data elements based on the one or more input embeddings. The one or more predictions may comprise one or more binary classification outputs for the respective one or more prediction encounter data elements. That is, the one or more predictions may comprise a projection that the one or more prediction encounter data elements will be included in the one or more input temporal sequence of encounters data records at a future time. In an example embodiment, the one or more predictions for the one or more prediction encounter data elements is associated with an onset of a diagnosis, event, or response to actions/treatments.

In some embodiments, the machine learning model generates one or more probability scores representative of a likelihood that the one or more input temporal sequence of encounters data records will include the one or more prediction encounter data elements. The machine learning model may comprise one or more initialized weights that are further fine-tuned (e.g., generating one or more fine-tuned weights by updating one or more initialized weights) to a target classification (e.g., relating to onset of a diagnosis, event, or response to actions/treatments) associated with the one or more prediction encounter data elements. In some embodiments, a prediction score describes a numerical value representative of a probability of a prediction associated with a target classification. For example, the one or more prediction encounter data elements associated with the target classification may comprise a prediction of codes that will appear in the future for a particular EMR record.

In some embodiments, at step/operation 808, the predictive data analysis computing entity 106 initiates the performance of one or more prediction-based actions based on the one or more predictions. Initiating the performance of the one or more prediction-based actions based on the one or more predictions comprises, for example, performing a resource-based action (e.g., allocation of resource), generating a diagnostic report, generating and/or executing action scripts, generating alerts or messages, or generating one or more electronic communications. The one or more prediction-based actions may further include displaying visual renderings of the aforementioned examples of prediction-based actions in addition to values, charts, and representations associated with the one or more predictions using a prediction output user interface.

Accordingly, as described above, various embodiments of the present disclosure make important technical contributions to improving predictive accuracy of a predictive machine learning model comprising a language machine learning model by generating training embeddings associated with data fields of structured data used for pre-training and fine-tuning the language machine learning model. This approach improves training speed and training efficiency of training predictive machine learning models. It is well-understood in the relevant art that there is typically a tradeoff between predictive accuracy and training speed, such that it is trivial to improve training speed by reducing predictive accuracy. Thus, the challenge is to improve training speed without sacrificing predictive accuracy through innovative model architectures. Accordingly, techniques that improve predictive accuracy without harming training speed, such as the techniques described herein, enable improving training speed given a constant predictive accuracy. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training machine learning models.

Some techniques of the present disclosure enable the generation of predictions that may be performed to initiate one or more predictive actions to achieve real-world effects. The disclosed generation of embeddings, pre-training and fine-tuning techniques of the present disclosure may be used, applied, and/or otherwise leveraged to generate a machine learning model, which may help a computer extract and learn features from structured data. The machine learning model of the present disclosure may be leveraged to initiate the performance of various computing tasks that improve the performance of a computing system (e.g., a computer itself, etc.) with respect to various predictive actions performed by the predictive data analysis computing entity 106, such as for the prediction of encounter data elements of temporal sequence of encounters data records. Example predictive actions may include generating a diagnostic report, displaying/providing resources, generating, and/or executing action scripts, generating alerts or reminders, or generating one or more electronic communications based on the predicted disease class.

In some examples, the computing tasks may include predictive actions that may be based on a prediction domain. A prediction domain may include any environment in which computing systems may be applied to achieve real-word insights, such as predictions (e.g., abstractive summaries, predictive intents, etc.), and initiate the performance of computing tasks, such as predictive actions e.g., updating user preferences, providing account information, cancelling an account, adding an account, etc.) to act on the real-world insights. These predictive actions may cause real-world changes, for example, by controlling a hardware component, providing alerts, interactive actions, and/or the like.

Examples of prediction domains may include financial systems, clinical systems, autonomous systems, robotic systems, and/or the like. Predictive actions in such domains may include the initiation of automated instructions across and between devices, automated notifications, automated scheduling operations, automated precautionary actions, automated security actions, automated data processing actions, automated data compliance actions, automated data access enforcement actions, automated adjustments to computing and/or human data access management, and/or the like.

In some embodiments, the training technique of process 400 and the predictive operations of process 800 are applied to initiate the performance of one or more predictive actions. A predictive action may depend on the prediction domain. In some examples, the predictive data analysis computing entity 106 may leverage the training technique to generate a machine learning model that may be leveraged to initiate the generation of a diagnostic report, display of resources, generation, and/or execution of action scripts, generation of alerts or reminders, or generation of one or more electronic communications based on one or more predictions generated by the machine learning model.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Example 1. A computer-implemented method comprising: generating, by one or more processors, a plurality of training embeddings based on a pre-training dataset, wherein the plurality of training embeddings comprises one or more of descriptive embeddings, sequential ordering embeddings, age/time embeddings, locale embeddings, or encounter number embeddings; generating, by the one or more processors, one or more initialized weights associated with respective one or more layers of a machine learning model based on the plurality of training embeddings; generating, by the one or more processors, one or more fine-tuned weights by updating at least a portion of the one or more initialized weights using a fine-tuning dataset associated with a target classification; generating, by the one or more processors and using the machine learning model, one or more prediction scores for one or more prediction encounter data elements associated with the target classification, based on one or more input temporal sequence of encounters data records comprising respective one or more input encounter data elements; and initiating, by the one or more processors, the performance of one or more prediction-based actions based on the one or more prediction scores.

Example 2. The computer-implemented method of any of the preceding examples, wherein the machine learning model comprises a transformer machine learning model architecture.

Example 3. The computer-implemented method of any of the preceding examples, wherein the machine learning model comprises a plurality of transformer layers, wherein each of the plurality of transformer layers comprises self-attention and a feedforward network.

Example 4. The computer-implemented method of any of the preceding examples, further comprising tokenizing at least a portion of the pre-training dataset by: determining a plurality of deciles for based on a plurality of scores; determining a plurality of maximum decile values associated with the plurality of deciles; determining one or more maximum score feature values for respective one or more of a plurality of scoring identifiers associated with the plurality of score feature values based on an exponential function comprising the plurality of maximum decile values; and assigning one or more pre-training score feature values to one or more of the plurality of deciles based on the plurality of maximum decile values.

Example 5. The computer-implemented method of any of the preceding examples, wherein generating the one or more initialized weights further comprises pre-training the one or more initialized weights by: determining one or more extra-record encounter data elements in one or more first training temporal sequence of encounters data records from the pre-training dataset; and determining one or more re-ordered encounter data elements in one or more second training temporal sequence of encounters data records from the pre-training dataset.

Example 6. The computer-implemented method of any of the preceding examples, wherein determining the one or more extra-record encounter data elements further comprises: replacing a training encounter data element in at least one of the one or more first training temporal sequence of encounters data records with a substitute training encounter data element; and determining, using the machine learning model, the substitute training encounter data element as an extra-record encounter data element.

Example 7. The computer-implemented method of any of the preceding examples, wherein determining one or more re-ordered encounter data elements further comprises: re-arranging one or more training encounter data elements in at least one of the one or more second training temporal sequence of encounters data records; and determining, using the machine learning model, the one or more training encounter data elements have been re-arranged.

Example 8. The computer-implemented method of any of the preceding examples, wherein at least one of the one or more input temporal sequence of encounters data records, the pre-training dataset, or the fine-tuning dataset comprise structured data from one or more electronic data records.

Example 9. The computer-implemented method of any of the preceding examples, wherein the pre-training dataset comprises one or more of codes, code types, temporal information, location type information, sequential ordering information, or utilization information.

Example 10. A computing system comprising memory and one or more processors communicatively coupled to the memory, the one or more processors configured to: generate a plurality of training embeddings based on a pre-training dataset, wherein the plurality of training embeddings comprises one or more of descriptive embeddings, sequential ordering embeddings, age/time embeddings, locale embeddings, or encounter number embeddings; generate one or more initialized weights associated with respective one or more layers of a machine learning model based on the plurality of training embeddings; generate one or more fine-tuned weights by updating at least a portion of the one or more initialized weights using a fine-tuning dataset associated with a target classification; generate, using the machine learning model, one or more prediction scores for one or more prediction encounter data elements associated with the target classification, based on one or more input temporal sequence of encounters data records comprising respective one or more input encounter data elements; and initiate the performance of one or more prediction-based actions based on the one or more prediction scores.

Example 11. The computing system of any of the preceding examples, wherein the machine learning model comprises a transformer machine learning model architecture.

Example 12. The computing system of any of the preceding examples, wherein the machine learning model comprises a plurality of transformer layers, wherein each of the plurality of transformer layers comprises self-attention and a feedforward network.

Example 13. The computing system of any of the preceding examples, wherein the one or more processors are further configured to tokenize at least a portion of the pre-training dataset by: determining a plurality of deciles for based on a plurality of scores; determining a plurality of maximum decile values associated with the plurality of deciles; determining one or more maximum score feature values for respective one or more of a plurality of scoring identifiers associated with the plurality of score feature values based on an exponential function comprising the plurality of maximum decile values; and assigning one or more pre-training score feature values to one or more of the plurality of deciles based on the plurality of maximum decile values.

Example 14. The computing system of any of the preceding examples, wherein the one or more processors are further configured to pre-train the one or more initialized weights by: determining one or more extra-record encounter data elements in one or more first training temporal sequence of encounters data records from the pre-training dataset; and determining one or more re-ordered encounter data elements in one or more second training temporal sequence of encounters data records from the pre-training dataset.

Example 15. The computing system of any of the preceding examples, wherein the one or more processors are further configured to: replace a training encounter data element in at least one of the one or more first training temporal sequence of encounters data records with a substitute training encounter data element; and determine, using the machine learning model, the substitute training encounter data element as an extra-record encounter data element.

Example 16. The computing system of any of the preceding examples, wherein the one or more processors are further configured to: re-arrange one or more training encounter data elements in at least one of the one or more second training temporal sequence of encounters data records; and determine, using the machine learning model, the one or more training encounter data elements have been re-arranged.

Example 17. The computing system of any of the preceding examples, wherein at least one of the one or more input temporal sequence of encounters data records, the pre-training dataset, or the fine-tuning dataset comprise structured data from one or more electronic data records.

Example 18. The computing system of any of the preceding examples, wherein the pre- training dataset comprises one or more of codes, code types, temporal information, location type information, sequential ordering information, or utilization information.

Example 19. One or more non-transitory computer-readable storage media including instructions that, when executed by one or more processors, cause the one or more processors to: generate a plurality of training embeddings based on a pre-training dataset, wherein the plurality of training embeddings comprises one or more of descriptive embeddings, sequential ordering embeddings, age/time embeddings, locale embeddings, or encounter number embeddings; generate one or more initialized weights associated with respective one or more layers of a machine learning model based on the plurality of training embeddings; generate one or more fine-tuned weights by updating at least a portion of the one or more initialized weights using a fine-tuning dataset associated with a target classification; generate, using the machine learning model, one or more prediction scores for one or more prediction encounter data elements associated with the target classification, based on one or more input temporal sequence of encounters data records comprising respective one or more input encounter data elements; and initiate the performance of one or more prediction-based actions based on the one or more prediction scores.

Example 20. The one or more non-transitory computer-readable storage media of any of the preceding examples, wherein the machine learning model comprises a transformer machine learning model architecture.

Example 21. The one or more non-transitory computer-readable storage media of any of the preceding examples, wherein the machine learning model comprises a plurality of transformer layers, wherein each of the plurality of transformer layers comprises self-attention and a feedforward network.

Example 22. The one or more non-transitory computer-readable storage media of any of the preceding examples, further including instructions that, when executed by the one or more processors, cause the one or more processors to tokenize at least a portion of the pre-training dataset by: determining a plurality of deciles for based on a plurality of scores; determining a plurality of maximum decile values associated with the plurality of deciles; determining one or more maximum score feature values for respective one or more of a plurality of scoring identifiers associated with the plurality of score feature values based on an exponential function comprising the plurality of maximum decile values; and assigning one or more pre-training score feature values to one or more of the plurality of deciles based on the plurality of maximum decile values.

Example 23. The one or more non-transitory computer-readable storage media of any of the preceding examples, further including instructions that, when executed by the one or more processors, cause the one or more processors to pre-train the one or more initialized weights by: determining one or more extra-record encounter data elements in one or more first training temporal sequence of encounters data records from the pre-training dataset; and determining one or more re-ordered encounter data elements in one or more second training temporal sequence of encounters data records from the pre-training dataset.

Example 24. The one or more non-transitory computer-readable storage media of any of the preceding examples, further including instructions that, when executed by the one or more processors, cause the one or more processors to: replace a training encounter data element in at least one of the one or more first training temporal sequence of encounters data records with a substitute training encounter data element; and determine, using the machine learning model, the substitute training encounter data element as an extra-record encounter data element.

Example 25. The one or more non-transitory computer-readable storage media of any of the preceding examples, further including instructions that, when executed by the one or more processors, cause the one or more processors to: re-arrange one or more training encounter data elements in at least one of the one or more second training temporal sequence of encounters data records; and determine, using the machine learning model, the one or more training encounter data elements have been re-arranged.

Example 26. The one or more non-transitory computer-readable storage media of any of the preceding examples, wherein at least one of the one or more input temporal sequence of encounters data records, the pre-training dataset, or the fine-tuning dataset comprise structured data from one or more electronic data records.

Example 27. The one or more non-transitory computer-readable storage media of any of the preceding examples, wherein the pre-training dataset comprises one or more of codes, code types, temporal information, location type information, sequential ordering information, or utilization information.

1. A computer-implemented method comprising:
generating, by one or more processors, a plurality of training embeddings based on a pre-training dataset, wherein the plurality of training embeddings comprises one or more of descriptive embeddings, sequential ordering embeddings, age/time embeddings, locale embeddings, or encounter number embeddings;
generating, by the one or more processors, one or more initialized weights associated with respective one or more layers of a machine learning model based on the plurality of training embeddings;
generating, by the one or more processors, one or more fine-tuned weights for the machine learning model by updating at least a portion of the one or more initialized weights using a fine-tuning dataset associated with a target classification;
generating, by the one or more processors and using the machine learning model, one or more prediction scores for one or more prediction encounter data elements associated with the target classification based on one or more input temporal sequence of encounters data records comprising respective one or more input encounter data elements; and
initiating, by the one or more processors, the performance of one or more prediction-based actions based on the one or more prediction scores.

2. The computer-implemented method of claim 1, wherein the machine learning model comprises a transformer machine learning model architecture.

3. The computer-implemented method of claim 1, wherein the machine learning model comprises a plurality of transformer layers, wherein each of the plurality of transformer layers comprises self-attention and a feedforward network.

4. The computer-implemented method of claim 1, further comprising tokenizing at least a portion of the pre-training dataset by:
determining a plurality of deciles based on a plurality of scores;
determining a plurality of maximum decile values associated with the plurality of deciles;
determining one or more maximum score feature values for respective one or more of a plurality of scoring identifiers associated with the plurality of score feature values based on an exponential function comprising the plurality of maximum decile values; and
assigning one or more pre-training score feature values to one or more of the plurality of deciles based on the plurality of maximum decile values.

5. The computer-implemented method of claim 1, wherein generating the one or more initialized weights further comprises pre-training the one or more initialized weights by:
determining one or more extra-record encounter data elements in one or more first training temporal sequence of encounters data records from the pre-training dataset; and
determining one or more re-ordered encounter data elements in one or more second training temporal sequence of encounters data records from the pre-training dataset.

6. The computer-implemented method of claim 5, wherein determining the one or more extra-record encounter data elements further comprises:
replacing a training encounter data element in at least one of the one or more first training temporal sequence of encounters data records with a substitute training encounter data element; and
determining, using the machine learning model, the substitute training encounter data element as an extra-record encounter data element.

7. The computer-implemented method of claim 5, wherein determining one or more re-ordered encounter data elements further comprises:
re-arranging one or more training encounter data elements in at least one of the one or more second training temporal sequence of encounters data records; and
determining, using the machine learning model, the one or more training encounter data elements have been re-arranged.

8. The computer-implemented method of claim 1, wherein at least one of the one or more input temporal sequence of encounters data records, the pre-training dataset, or the fine-tuning dataset comprise structured data from one or more electronic data records.

9. The computer-implemented method of claim 1, wherein the pre-training dataset comprises one or more of codes, code types, temporal information, location type information, sequential ordering information, or utilization information.

10. A computing system comprising memory and one or more processors communicatively coupled to the memory, the one or more processors configured to:
generate a plurality of training embeddings based on a pre-training dataset, wherein the plurality of training embeddings comprises one or more of descriptive embeddings, sequential ordering embeddings, age/time embeddings, locale embeddings, or encounter number embeddings;
generate one or more initialized weights associated with respective one or more layers of a machine learning model based on the plurality of training embeddings;
generate one or more fine-tuned weights for the machine learning model by updating at least a portion of the one or more initialized weights using a fine-tuning dataset associated with a target classification;
generate, using the machine learning model, one or more prediction scores for one or more prediction encounter data elements associated with the target classification, based on one or more input temporal sequence of encounters data records comprising respective one or more input encounter data elements; and
initiate the performance of one or more prediction-based actions based on the one or more prediction scores.

11. The computing system of claim 10, wherein the one or more processors are further configured to tokenize at least a portion of the pre-training dataset by:
determining a plurality of deciles for based on a plurality of scores;
determining a plurality of maximum decile values associated with the plurality of deciles;
determining one or more maximum score feature values for respective one or more of a plurality of scoring identifiers associated with the plurality of score feature values based on an exponential function comprising the plurality of maximum decile values; and
assigning one or more pre-training score feature values to one or more of the plurality of deciles based on the plurality of maximum decile values.

12. The computing system of claim 10, wherein the one or more processors are further configured to pre-train the one or more initialized weights by:
determining one or more extra-record encounter data elements in one or more first training temporal sequence of encounters data records from the pre-training dataset; and
determining one or more re-ordered encounter data elements in one or more second training temporal sequence of encounters data records from the pre-training dataset.

13. The computing system of claim 12, wherein the one or more processors are further configured to:
replace a training encounter data element in at least one of the one or more first training temporal sequence of encounters data records with a substitute training encounter data element; and
determine, using the machine learning model, the substitute training encounter data element as an extra-record encounter data element.

14. The computing system of claim 12, wherein the one or more processors are further configured to:
re-arrange one or more training encounter data elements in at least one of the one or more second training temporal sequence of encounters data records; and
determine, using the machine learning model, the one or more training encounter data elements have been re-arranged.

15. One or more non-transitory computer-readable storage media including instructions that, when executed by one or more processors, cause the one or more processors to:
generate a plurality of training embeddings based on a pre-training dataset, wherein the plurality of training embeddings comprises one or more of descriptive embeddings, sequential ordering embeddings, age/time embeddings, locale embeddings, or encounter number embeddings;
generate one or more initialized weights associated with respective one or more layers of a machine learning model based on the plurality of training embeddings;
generate one or more fine-tuned weights for the machine learning model by updating at least a portion of the one or more initialized weights using a fine-tuning dataset associated with a target classification;
generate, using the machine learning model, one or more prediction scores for one or more prediction encounter data elements associated with the target classification, based on one or more input temporal sequence of encounters data records comprising respective one or more input encounter data elements; and
initiate the performance of one or more prediction-based actions based on the one or more prediction scores.

16. The one or more non-transitory computer-readable storage media of claim 15, wherein the machine learning model comprises a plurality of transformer layers, wherein each of the plurality of transformer layers comprises self-attention and a feedforward network.

17. The one or more non-transitory computer-readable storage media of claim 15, further including instructions that, when executed by the one or more processors, cause the one or more processors to tokenize at least a portion of the pre-training dataset by:
determining a plurality of deciles for based on a plurality of scores;
determining a plurality of maximum decile values associated with the plurality of deciles;
determining one or more maximum score feature values for respective one or more of a plurality of scoring identifiers associated with the plurality of score feature values based on an exponential function comprising the plurality of maximum decile values; and
assigning one or more pre-training score feature values to one or more of the plurality of deciles based on the plurality of maximum decile values.

18. The one or more non-transitory computer-readable storage media of claim 15, further including instructions that, when executed by the one or more processors, cause the one or more processors to pre-train the one or more initialized weights by:
determining one or more extra-record encounter data elements in one or more first training temporal sequence of encounters data records from the pre-training dataset; and
determining one or more re-ordered encounter data elements in one or more second training temporal sequence of encounters data records from the pre-training dataset.

19. The one or more non-transitory computer-readable storage media of claim 18, further including instructions that, when executed by the one or more processors, cause the one or more processors to:
replace a training encounter data element in at least one of the one or more first training temporal sequence of encounters data records with a substitute training encounter data element; and
determine, using the machine learning model, the substitute training encounter data element as an extra-record encounter data element.

20. The one or more non-transitory computer-readable storage media of claim 18, further including instructions that, when executed by the one or more processors, cause the one or more processors to:
re-arrange one or more training encounter data elements in at least one of the one or more second training temporal sequence of encounters data records; and
determine, using the machine learning model, the one or more training encounter data elements have been re-arranged.
